(19) United States
(12) Patent Application Publication
(10) Pub. No.: US 2016/0139479 A1
(43) Pub. Date: May 19, 2016

(54) DISPLAY UNIT AND ELECTRONIC APPARATUS

(71) Applicant: SONY CORPORATION, TOKYO (JP)

(72) Inventors: NORIYUKI HIRAI, KANAGAWA (JP); MASAKAZU MITSUGI, KANAGAWA (JP); ISAO TAKAHASHI, KANAGAWA (JP)

(21) Appl. No.: 14/898,462

(22) PCT Filed: Jun. 6, 2014
(86) PCT No.: PCT/JP2014/003039

§ 371 Date: Dec. 14, 2015

(30) Foreign Application Priority Data
Jun. 24, 2013 (JP) 2013-131397

(51) Int. Cl. G02F 1/167

(52) U.S. Cl. CPC G02F 1/167; G02F 2001/1672

(57) ABSTRACT

A display unit includes: a first particle and a porous layer. The first particle is contained in each of a plurality of cells. The porous layer is provided in the cells, and is partitioned into portions corresponding to the respective cells.

### CROSS REFERENCE TO RELATED APPLICATIONS

This application claims the benefit of Japanese Priority Patent Application JP 2013-131397 filed Jun. 24, 2013, the entire contents of each which is incorporated herein by reference.

### TECHNICAL FIELD

The present technology relates to a display unit including a porous layer, and an electronic apparatus including the display unit.

### BACKGROUND ART

In recent years, demand for display units with low power consumption and high image quality have been growing with the widespread use of mobile devices such as cellular phones and personal digital assistants. In particular, the recent launch of electronic book distribution service causes demand for displays with display quality suitable for reading.

As such displays, there have been proposed various kinds of displays including cholesteric liquid crystal displays, electrophoretic displays, electrical oxidation-reduction type displays, electric twist ball type displays; however, reflective displays are advantageous for reading. As with paper, the reflective displays perform display in a light state with use of reflection (scattering) of outside light; therefore, display quality closer to that of paper is obtainable in the reflective displays.

In the reflective displays, an electrophoretic display using an electrophoretic phenomenon has low power consumption and high response speed; therefore, the electrophoretic display is expected as a prominent candidate. As a displaying method by the electrophoretic display, the following two methods have been mainly proposed.

In one of the methods, two kinds of charged particles are dispersed in an insulating liquid to be moved by an electric field. These two kinds of charged particles have different optical reflection properties from each other, and are opposite in polarity. In this method, distribution states of the charged particles vary depending on the electric field to display an image.

In the other method, charged particles are dispersed in an insulating liquid, and a porous layer is provided (for example, refer to PTL 1). In this method, charged particles moves through pores of the porous layer depending on an electric field. The charged particles are contained in a space (a cell) divided by a partition wall, and the charged particles moves in this cell. The porous layer may be configured of, for example, a fibrous structure such as a polymer film holding a non-migrating particle.

### CITATION LIST

### Patent Literature

[PTL 1] Japanese Unexamined Patent Application Publication No. 2012-173316

### SUMMARY

### Technical Problem

However, in existing electrophoretic displays, it is difficult to sufficiently suppress movement of charged particles between cells, thereby causing an issue that a scattering state of charged particles is turned to a nonuniform state. Therefore, display characteristics such as contrast vary in a plane.

It is desirable to provide a display unit that reduces variation in display characteristics in a plane, and an electronic apparatus.

### Solution to Problem

According to an embodiment of the present technology, there is provided a display unit including: a first particle contained in each of a plurality of cells; and a porous layer provided in the cells, and partitioned into portions corresponding to the respective cells.

According to an embodiment of the present technology, there is provided an electronic apparatus provided with a display unit, the display unit including: a first particle contained in each of a plurality of cells; and a porous layer provided in the cells, and partitioned into portions corresponding to the respective cells.

In the display unit according to the embodiment of the present technology, the porous layer is partitioned into portions corresponding to the respective cells; therefore, movement of the first particle between the cells through the porous layer is suppressed. In other words, a dispersion state of the first particle is maintained in a desired state.

### Advantageous Effects of Invention

In the display unit according to the embodiment of the present technology, the porous layer is partitioned into portions corresponding to respective cells; therefore, a dispersion state of the cell is allowed to be maintained in a desired state, and variation in display characteristics in a plane is allowed to be reduced.

It is to be understood that both the foregoing general description and the following detailed description are exemplary, and are intended to provide further explanation of the technology as claimed.

### BRIEF DESCRIPTION OF DRAWINGS

[FIG. 1]

FIG. 1 is a sectional view illustrating a configuration of a display unit according to an embodiment of the present technology.

[FIG. 2]

FIG. 2 is a plan view illustrating a configuration of an electrophoresis device illustrated in FIG. 1.

[FIG. 3]

FIG. 3 is a plan view illustrating a configuration of a partition wall illustrated in FIG. 1.

[FIG. 4A]

FIG. 4A is a sectional view illustrating an example of a process of manufacturing the display unit illustrated in FIG. 1.

[FIG. 4B]

FIG. 4A is a sectional view illustrating a process following FIG. 4A.

[FIG. 5]

FIG. 5 is a sectional view for describing an operation of the display unit illustrated in FIG. 1.

[FIG. 6]

FIG. 6 is a sectional view illustrating a process of manufacturing a display unit according to a comparative example.

[FIG. 7]

FIG. 7 is a sectional view illustrating a configuration of a main part of a display unit according to Modification Example 1.

[FIG. 8]

FIG. 8 is a sectional view illustrating a configuration of a main part of a display unit according to Modification Example 2.

[FIG. 9]

FIG. 9 is a sectional view illustrating another shape of a partition wall illustrated in FIG. 8.

[FIG. 10]

FIG. 10 is a sectional view for describing a relationship between the partition wall and a drive substrate illustrated in FIG. 8.

[FIG. 11]

FIG. 11 is a sectional view illustrating a configuration of a display unit according to Modification Example 3.

[FIG. 12A]

FIG. 12A is a perspective view illustrating an appearance of Application Example 1.

[FIG. 12B]

FIG. 12B is a perspective view illustrating another example of an electronic book illustrated in FIG. 12A.

[FIG. 13]

FIG. 13 is a perspective view illustrating an appearance of Application Example 2.

[FIG. 14]

FIG. 14 is a perspective view illustrating an appearance of Application Example 3.

[FIG. 15A]

FIG. 15A is a perspective view illustrating an appearance viewed from a front side of Application Example 4.

[FIG. 15B]

FIG. 15B is a perspective view illustrating an appearance viewed from a back side of Application Example 4.

[FIG. 16]

FIG. 16 is a perspective view illustrating an appearance of Application Example 5.

[FIG. 17]

FIG. 17 is a perspective view illustrating an appearance of Application Example 6.

[FIG. 18A]

FIG. 18A is a front view, a left side view, a right side view, a top view, and a bottom view in a state in which Application Example 7 is closed.

[FIG. 18B]

FIG. 18B is a front view and a side view in a state in which Application Example 7 is opened.

[FIG. 19]

FIG. 19 is a diagram for describing measurement of reflectivity of display units of Experimental Examples 1 and 2.

[FIG. 20]

FIG. 20 is a plan view illustrating another example of the partition wall illustrated in FIG. 3.

### DESCRIPTION OF EMBODIMENTS

Some embodiments of the present technology will be described in detail below referring to the accompanying drawings. It is to be noted that description will be given in the following order.
1. Embodiment (Display unit: Example including a tapered partition wall)
2. Modification Example 1 (Example in which a length of a fibrous structure is reduced)
3. Modification Example 2 (Example of a partition wall including a cutaway section)
4. Modification Example 3 (Example including a rectangular parallelepiped partition wall)
5. Application Examples
6. Experimental Examples

### Embodiment

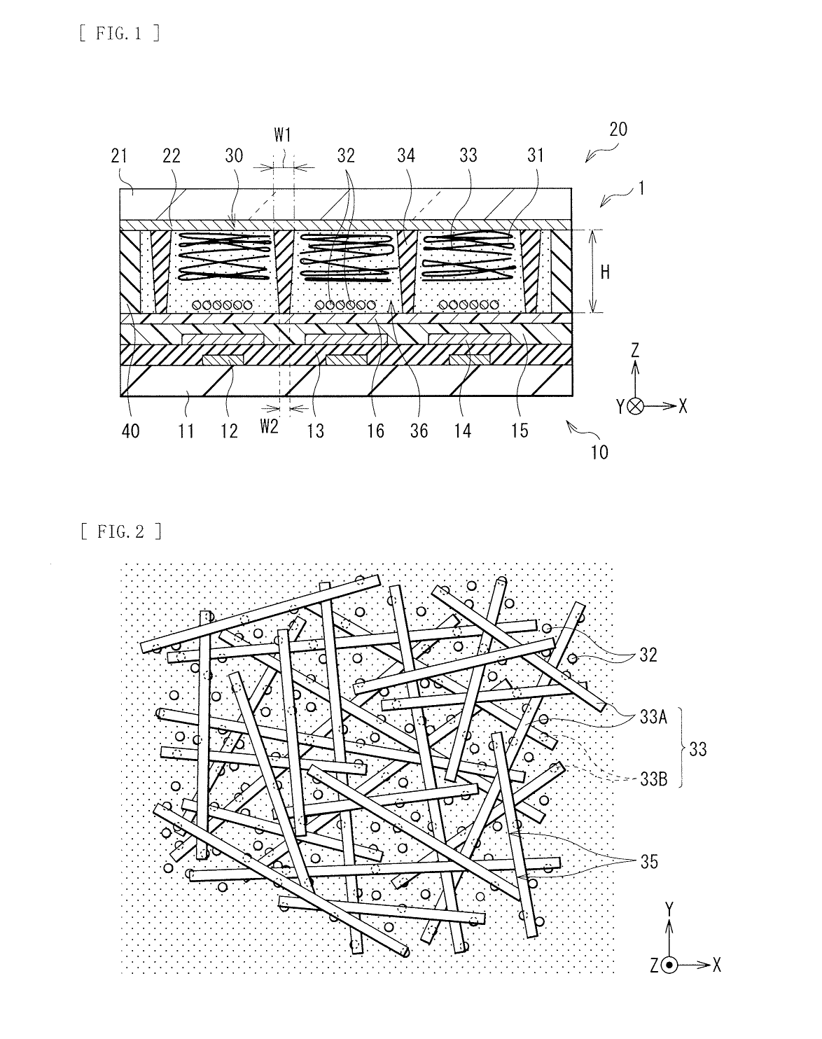

FIG. 1 illustrates a sectional configuration of a display unit (a display unit 1) according to an embodiment of the present technology. The display unit 1 is an electrophoretic display unit that displays an image with use of an electrophoretic phenomenon, and includes an electrophoresis device 30 between a drive substrate 10 and a counter substrate 20. In this display unit 1, an image is displayed on the counter substrate 20. A sealant 40 is provided to outer edges of the drive substrate 10 and the counter substrate 20. It is to be noted that FIG. 1 schematically illustrates a configuration of the display unit 1, and dimensions and a shape of the display unit 1 may be different from actual dimensions and an actual shape.

The electrophoresis device 30 is applicable to various uses. A case where the electrophoresis device 30 is applied to the display unit 1 will be described below; however, the configuration of the display unit 1 is merely an example, and may be modified as appropriate. Moreover, the electrophoresis device 30 may be used for units other than the display unit, and the application of the electrophoresis device 30 is not specifically limited.

The drive substrate 10 may include, for example, TFTs (Thin Film Transistors) 12, a protective layer 13, and pixel electrodes 14 in this order on one surface of a supporting member 11. The TFTs 12 and the pixel electrodes 14 may be arranged, for example, in a matrix form or a segment form according to a pixel arrangement.

The supporting member 11 may be configured of, for example, a plate-like inorganic material, a plate-like metal material, or a plate-like plastic material. Examples of the inorganic material may include silicon (Si), silicon oxide (SiO_{X}), silicon nitride (SiN_{X}), and aluminum oxide (AlOₓ). Examples of silicon oxide may include glass and spin-on glass (SOG). Examples of the metal material may include aluminum (Al), nickel (Ni), and stainless, and examples of the plastic material may include polycarbonate (PC), polyamide (PA), polyimide (PI), polyethylene terephthalate (PET), polyethylene naphthalate (PEN), and polyethyl ether ketone (PEEK).

In the display unit 1, since an image is displayed on the counter substrate 20, the supporting member 11 may be opaque. The supporting member 11 may be configured of a substrate with rigidity such as a wafer, and may be configured of a flexible thin glass, a flexible film, or the like. The flexible (foldable) display unit 1 is achievable by using a flexible material for the supporting member 11.

Each of the TFTs 12 is a switching device for selection of a pixel. Each of the TFTs 12 may be an inorganic TFT using an inorganic semiconductor layer as a channel layer, or an organic TFT using an organic semiconductor layer as a channel layer. The protective layer 13 may be made of, for example, an insulating resin material such as polyimide, and planarizes a surface where the TFTs 12 are disposed of the supporting member 11. The pixel electrodes 14 may be formed of, for example, a conductive material such as gold (Au), silver (Ag), copper (Cu), aluminum (Al), an aluminum alloy, or indium oxide-tin oxide (ITO). The pixel electrodes 14 may be made of a plurality of kinds of conductive materials. The pixel electrode 14 is connected to the TFT 12 through a contact hole (not illustrated) provided to the protective layer 13.

An adhesive layer (or a bonding layer) 15 and a seal layer 16 are provided between the drive substrate 10 and the electrophoresis device 30. The adhesive layer 15 is configured to bond the drive substrate 15 and the seal layer 16 together, and may be made of, for example, an acrylic-based resin or a urethane-based resin. A rubber-based adhesive sheet or the like may be used as the adhesive layer 15. The seal layer 16 is configured to seal an insulating liquid (an insulating liquid 31 that will be described later) in the electrophoresis device 30 and to prevent entry of water or the like into the electrophoresis device 30, and may be made of, for example, an acrylic-based resin, an urethane-based resin, a rubber-based adhesive sheet, or the like.

The counter substrate 20 may include, for example, a supporting member 21 and a counter electrode 22, and the counter electrode 22 is disposed over an entire surface (a surface facing the drive substrate 10) of the supporting member 21. As with the pixel electrodes 14, the counter electrode 22 may be arranged in a matrix form or a segment form.

For the supporting member 21, a material similar to that of the supporting member 11 may be used, as long as the material has light transparency. For the counter electrode 22, for example, a light-transmissive conductive material (a transparent electrode material) such as indium oxide-tin oxide (ITO), antimony oxide-tin oxide (ATO), fluorine-doped tin oxide (FTO), or aluminum-doped zinc oxide (AZO) may be used.

Since the electrophoresis device 30 is viewed through the counter electrode 22, light transparency (transmittance) of the counter electrode 22 may be preferably as high as possible, and may be, for example, about 80% or more. Moreover, electrical resistance of the counter electrode 22 may be preferably as low as possible, and may be, for example, about 500 ohm/sq or less.

The electrophoresis device 30 is configured to provide contrast in each pixel with use of the electrophoretic phenomenon, and includes migrating particles 32 (first particles), a porous layer 33, and a partition wall 34. The migrating particles 32 and the porous layer 33 are provided to each of spaces (cells 36) separated from one another by the partition wall 23. In other words, the partition wall 34 is provided between adjacent cells 36.

A space enclosed by the drive substrate 10 (the seal layer 16), the counter substrate 20, and the sealant 40 is filled with the insulating liquid 31, and the insulating liquid 31 may be made of, for example, an organic solvent such as paraffin or isoparaffin. As the insulating liquid 31, one kind of organic solvent or a plurality of kinds of organic solvents may be used. Viscosity and a refractive index of the insulating liquid 31 may be preferably as low as possible. When the viscosity of the insulating liquid 31 is low, mobility (response speed) of the migrating particles 32 is improved. Accordingly, energy (power consumption) necessary for movement of the migrating particles 32 is reduced. When the refractive index of the insulating liquid 31 is low, a difference in refractive index between the insulating liquid 31 and the porous layer 33 is increased to increase light reflectivity of the porous layer 33. The refractive index of the insulating liquid 31 may be, for example, about 1.48.

For example, a colorant, a charge control agent (a charge regulation agent), a dispersion stabilizer, a viscosity modifier, a surfactant, resin, or the like may be added to the insulating liquid 31.

The migrating particles 32 dispersed in the insulating liquid 31 are two or more charged particles (electrophoretic particles), and the charged migrating particles 32 move in a thickness direction of the porous layer 33 (a Z direction in FIG. 1) between the pixel electrode 14 and the counter electrode 22 depending on an electric field. The number of migrating particles 32 may be one. The migrating particles 32 have an arbitrary optical reflection property (light reflectivity), and a difference in light reflectivity between the migrating particles 32 and the porous layer 33 provides contrast. In the display unit 1, the light reflectivity of the migrating particles 32 is lower than that of the porous layer 33, and display in a dark state is performed by the migrating particles 32, and display in a light state is performed by the porous layer 33.

Therefore, when the electrophoresis device 30 is viewed from outside, the migrating particles 32 are visually recognized, for example, as a black color or a color close to black. The color of the migrating particles 32 is not specifically limited, as long as contrast is allowed to be provided.

The migrating particles 32 may be configured of, for example, particles (power) of an organic pigment, an inorganic pigment, a dye, a carbon material, a metal material, metal oxide, glass, or a polymer material (resin). For the migrating particles 32, one kind or two or more kinds selected from these materials may be used. The migrating particles 32 may be configured of pulverized particles, capsule particles, or the like of a resin solid including the above-described particles. Each of the migrating particles 32 may have a particle diameter that is small enough to allow the migrating particle 32 to pass through the porous layer 33 (more specifically, a pore 35 in FIG. 2 that will be described later), and the particle diameter of each of the migrating particles 32 may be, for example, about 10 nm to about 500 nm both inclusive. It is to be noted that materials corresponding to the above-described carbon material, the above-described metal material, the above-described metal oxide, the above-described glass, and the above-described polymer material are excluded from materials corresponding to the organic pigment, the inorganic pigment, and the dye.

Examples of the above-described organic pigment may include azo-based pigments, metal-complex azo-based pigments, polycondensation azo-based pigments, flavanthrone-based pigments, benzimidazolone-based pigments, phthalocyanine-based pigments, quinacridone -based pigments, anthraquinone-based pigments, perylene-based pigments, perinone-based pigments, anthrapyridine-based pigments, pyranthrone-based pigments, dioxazine-based pigments, thioindigo-based pigments, isoindolinone-based pigments, quinophthalone-based pigments, and indanthrene-based pigments. Examples of the inorganic pigments may include zinc white, antimony white, iron black, titanium boride, red iron oxide, Mapico Yellow, minium, cadmium yellow, zinc sulfide, lithopone, barium sulfide, cadmium selenide, calcium carbonate, barium sulfate, lead chromate, lead sulfate, barium carbonate, white lead, and alumina white. Examples of the dyes may include nigrosine-based dyes, azo-based dyes, phthalocyanine-based dyes, quinophthalone-based dyes, anthraquinone-based dyes, and methine-based dyes. Examples of the carbon material may include carbon black. Examples of the metal material may include gold, silver, and copper. Examples of the metal oxide may include titanium oxide, zinc oxide, zirconium oxide, barium titanate, potassium titanate, copper-chromium oxide, copper-manganese oxide, copper-iron-manganese oxide, copper-chromium-manganese oxide, and copper-iron-chromium oxide. Examples of the polymer material may include a polymer compound into which a functional group having a light absorption region in a visible light region is introduced. As long as the polymer compound has the light absorption region in the visible light region, the kind of the polymer compound is not specifically limited.

More specifically, for the migrating particles 32 that are used to perform display in a dark state, for example, the carbon material such as carbon black, or the metal oxide such as copper-chromium oxide, copper-manganese oxide, copper-iron-manganese oxide, copper-chromium-manganese oxide, or copper-iron-chromium oxide may be used. In particular, the carbon material may be preferably used for the migrating particles 32. The migrating particles 32 made of the carbon material exhibit high chemical stability, high mobility, and high light absorption.

The content (concentration) of the migrating particles 32 in the insulating liquid 31 may be, for example, but not specifically limited to, about 0.1 wt % to about 10 wt % both inclusive. In this concentration range, a shielding property and mobility of the migrating particles 32 are secured. More specifically, the content of the migrating particles 32 is smaller than about 0.1 wt %, the migrating particles 32 are less likely to shield (obscure) the porous layer 33, and it may be difficult to provide sufficient contrast. On the other hand, when the content of the migrating particles 32 is larger than about 10 wt %, dispersibility of the migrating particles 32 decreases and thus the migrating particles 32 are less likely to migrate, and the migrating particles 32 may be agglomerated.

It may be preferable that the migrating particles 32 be easily dispersed and charged in the insulating liquid 31 over a long time, and be less likely to be absorbed by the porous layer 33. Therefore, for example, a dispersant or a charge control agent may be added to the insulating liquid 31. Both of the dispersant and the charge control agent may be used.

The dispersant or the charge control agent may have, for example, one or both of a positive charge and a negative charge, and is used to increase a charge amount in the insulating liquid 31 and to disperse the migrating particles 32 by electrostatic repulsion. Examples of such a dispersant may include a Solsperse series manufactured by Lubrizol corp., a BYK series and an Anti-Terra series manufactured by BYK-Chemie, and Span series manufactured by ICI Americas Inc.

To improve dispersibility of the migrating particles 32, surface treatment may be subjected to the migrating particles 32. Examples of the surface treatment may include rosin treatment, surfactant treatment, pigment derivative treatment, coupling agent treatment, graft polymerization treatment, and microencapsulation treatment. In particular, dispersion stability is allowed to be maintained for a long time by performing the graft polymerization treatment, the microencapsulation treatment, or a combination thereof.

For such surface treatment, for example, a material (a absorbent material) having a functional group that is absorbable on a surface of the migrating particle 32 and a polymerizable functional group may be used. The absorbable functional group is determined depending on a material forming the migrating particles 32. For example, in a case where the migrating particles 32 are made of a carbon material such as carbon black, an aniline derivative such as 4-vinyl aniline is allowed to be absorbed, and in a case where the migrating particles 32 are made of metal oxide, an organosilane derivative such as methacrylate 3-(trimethoxy cyril) propyl is allowed to be absorbed. Examples of the polymerizable functional group may include a vinyl group, an acrylic group, and a methacryl group.

A polymerizable function group may be introduced into and grafted to the surface of the migrating particle 32 to perform surface treatment (a graft material). The graft material may include, for example, a polymerizable functional group and a dispersion functional group. The dispersion functional group allows the migrating particles 32 to be dispersed in the insulating liquid 31, and allows dispersibility to be maintained by steric hindrance thereof. For example, in a case where the insulating liquid 31 is paraffin, a branched alkyl group or the like may be used as the dispersion functional group. Examples of the polymerizable functional group may include a vinyl group, an acrylic group, and a methacryl group. For example, a polymerization initiator such as azobisisobutyronitrile (AIBN) may be used for polymerization and grafting of the graft material.

Regarding a detailed technique of dispersing the migrating particles 32 in the insulating liquid 31, reference is made to a book such as “Dispersion Technique of Ultrafine Particles and Evaluation Thereof Surface Treatment, Pulverizing, and Dispersion Stabilization in Gas, Liquid, and Polymer” published by Science & technology Co., Ltd.

The porous layer 33 is capable of shielding the migrating particles 32. As illustrated in FIG. 2, the porous layer 33 includes a fibrous structure 33A and non-migrating particles 33B (second particles) held by the fibrous structure 33A. In this embodiment, the porous layer 33 is partitioned into portions corresponding to respective cells 36. In other words, the porous layer 33 in each cell 36 is discontinuous to the porous layers 33 in other cells 36. As will be described in detail later, the movement of the migrating particles 32 between the cells 36 is thus allowed to be suppressed, and display characteristics in a plane is thus allowed to be maintained uniform. The porous layers 33 in the cells 36 separated from one another are allowed to be confirmed with use of, for example, a SEM (Scanning Electron Microscope) or the like.

The porous layer 33 is a three-dimensional structure (an irregular network structure such as a nonwoven fabric) formed of a fibrous structure 33A, and has a plurality of openings (pores 35). When the three-dimensional structure of the porous layer 33 is configured of the fibrous structure 33A, a sufficiently large size of the pore 35 allowing the migrating particles 32 to move is allowed to be secured, and high contrast is allowed to be maintained in spite of the porous layer 33 with a small thickness. More specifically, light (outside light) is irregularly reflected (multiply scattered) by the three-dimensional structure of the porous layer 33 to cause an increase in light reflectivity of the porous layer 33. Therefore, even if the thickness of the porous layer 33 is small, high light reflectivity is obtainable. Moreover, when the fibrous structure 33A is used, the average pore diameter of the pore 35 is increased, and a large number of pores 35 are provided to the porous layer 33. Therefore, the migrating particles 32 easily move through the pores 35, the response speed is improved, and energy necessary to move the migrating particles 32 is further reduced. Such a porous layer 33 may have, for example, a thickness (in the Z direction) of about 5 micrometers to about 100 micrometers both inclusive.

The fibrous structure 33 is a fibrous material having a sufficient length with respect to a fiber diameter (a diameter). For example, a plurality of fibrous structures 33A may be gathered in a randomly overlapped manner to form the porous layer 33. One continuous fibrous structure 33A may be randomly tangled to form the porous layer 33. Alternatively, the porous layer 33 configured of one fibrous structure 33A and the porous layer 33 configured of a plurality of fibrous structures 33A may be mixed. FIG. 2 illustrates the porous layer 33 configured of a plurality of fibrous structures 33A. One fibrous structure 33A is contained in one cell 36, and the fibrous structures 33A in the cells 36 are separated from one another. As long as the fibrous structures 33A in the cells 36 are separated from one another, a plurality of fibrous structures 33A may be contained in one cell 36. It is to be noted that, unless effects of the present technology are impaired, the fibrous structure 33A may straddle over a boundary between the cells 36.

The fibrous structure 33A may be made of, for example, a polymer material, an inorganic material, or the like. Examples of the polymer material may include nylon, polylactic acid, polyamide, polyimide, polyethylene terephthalate, polyacrylonitrile, poly(methyl methacrylate), polyethylene oxide, polyvinyl carbazole, polyvinyl chloride, polyurethane, polystyrene, polyvinyl alcohol, polysulfone, polyvinylpyrrolidone, polyvinylidene fluoride, polyhexafluoropropylene, cellulose acetate, collagen, gelatin, chitosan, and copolymers thereof. Examples of the inorganic material may include titanium oxide and the like. The polymer material may be preferably used for the fibrous structure 33A. It is because the polymer material has, for example, low reactivity with respect to light or the like and is chemically stable. In other words, use of the polymer material is allowed to prevent unintentional decomposition of the fibrous structure 33A. In a case where the fibrous structure 33A is made of a highly reactive material, a surface of the fibrous structure 33A may be preferably covered with an optional protective layer.

For example, the fibrous structure 33A may extend linearly. The fibrous structure 33A may have any shape, for example, the fibrous structure 33A may be curled, or bent at some point. Alternatively, the fibrous structure 33A may be branched at some point, or undulated. When the undulated fibrous structures 33A are tangled with one another, the configuration of the porous layer 33 is complicated, and optical characteristics are allowed to be improved accordingly.

An average fiber diameter of the fibrous structure 33A may be, for example, about 1 nm to about 2000 nm both inclusive, and may be preferably about 1 nm to 1000 nm both inclusive. A method of forming a porous layer made of cellulose, velvet, or the like has been proposed (refer to Japanese Examined Patent Application Publication No. S50-15120). However, refractive indices of cellulose and velvet are close to that of the insulating liquid; therefore, contrast may be reduced. Moreover, the fiber diameters of cellulose and velvet are as large as about 10 micrometers to about 100 micrometers both inclusive. On the other hand, as described above, when the average fiber diameter is reduced, light is easily diffused, and the diameter of the pore 35 is increased. The fiber diameter is determined so as to allow the fibrous structure 33A to hold the non-migrating particles 33B. The average fiber diameter is allowed to be measured by microscopic observation with use of a scanning electron microscope or the like. The average length of the fibrous structure 33A is optionally set. The fibrous structure 33A may be formed by, for example, a phase separation method, a phase inversion method, an electrostatic (electric field) spinning method, a melt spinning method, a wet spinning method, a dry spinning method, a gel spinning method, a sol-gel method, or a spray coating method. When such a method is used, the fibrous structure 33A with a sufficient length with respect to the fiber diameter is allowed to be formed easily and stably.

The fibrous structure 33A with higher light reflectivity than that of the migrating particle 32 may be preferably used. With use of such a fibrous structure 33A, contrast by a difference in light reflectivity between the porous layer 33 and the migrating particles 32 is easily formed. In a case where the fibrous structure 33A does not substantially affect light reflectivity of the porous layer 33, i.e., in a case where light reflectivity of the porous layer 33 is determined by the non-migrating particle 33B, the fibrous structure 33A exhibiting light transparency (colorless and transparent) may be used in the insulating liquid 31.

The pores 35 are formed by a plurality of fibrous structures 33A overlapping one another or one tangled fibrous structure 33A. The pore 35 may preferably have a largest possible average diameter so as to allow the migrating particle 32 to easily move through the pore 35. The average diameter of the pore 35 may be, for example, about 0.1 micrometers to about 10 micrometers both inclusive.

The non-migrating particles 33B are fixed in the fibrous structure 33A, and are two or more particles that do not electrically migrate. The number of non-migrating particles 33B may be one. The non-migrating particles 33B may be embedded in the fibrous structure 33A holding the non-migrating particles 33B, or may be exposed in part from the fibrous structure 33A. The non-migrating particles 33B are provided in each of the cells 36 together with the fibrous structure 33A.

The non-migrating particles 33B with light reflectivity different from that of the migrating particles 32, more specifically with higher light reflectivity than that of the migrating particles 32 are used. The non-migrating particles 33B may be made of a material similar to that described in the above-described migrating particles 32. More specifically, for the non-migrating particles 33B used to perform display in a light state, metal oxide such as titanium oxide, zinc oxide, zirconium oxide, barium titanate, or potassium titanate may be preferably used. The metal oxide allows the non-migrating particles 33B to obtain high chemical stability, high fixity, and high light reflectivity. The materials of the non-migrating particles 33B and the migrating particles 32 may be the same as each other or different from each other. The non-migrating particles 33B are visually recognized from outside as, for example, white or a color close to white. The particle diameter of the non-migrating particle 33B may be, for example, about 10 nm to about 1000 nm both inclusive.

The partition wall 34 is a columnar partition extending toward a direction (the Z direction) where the drive substrate 10 and the counter substrate 20 are laminated, and is in contact with the drive substrate 10 and the counter substrate 20. More specifically, one side of the partition wall 34 is in contact with the seal layer 16, and the other side of the partition wall 34 is in contact with the counter electrode 22. When such a partition wall 34 is provided, the migrating particles 32 are contained in each of the cells 36, and movement of the migrating particles 32 between the cells 36 is preventable. Therefore, display unevenness caused by diffusion, convection, and agglomeration of the migrating particles 32 is allowed to be suppressed, thereby improving image quality. The heights (Z direction) of the partition walls 34 may be preferably aligned with one another. When the partition walls 34 with a same height are provided, a distance (a gap) between the seal layer 16 and the counter electrode 22 is uniformly kept in an entire plane, and electric field strength is allowed to be uniformly maintained. Accordingly, variation in response speed is eliminated. A gap H between the drive substrate 10 and the counter substrate 20 is determined by the height of the partition wall 34. The size of the gap H may be preferably reduced. Accordingly, power consumption is allowed to be reduced. The height of the partition wall 34 may be, for example, about 1 micrometers to about 100 micrometers both inclusive.

The partition wall 34 may have, for example, a shape with a decreasing width (in an X direction) from the counter substrate 20 to the drive substrate 10, i.e., a so-called inverse tapered shape. A largest width W1 (a width of a surface facing the counter substrate 20) of the partition wall 34 may be, for example, about 5 micrometers to about 50 micrometers both inclusive, and a smallest width W2 (a width of a surface facing the drive substrate 10) of the partition wall 34 may be, for example, about 1 micrometers to about 30 micrometers both inclusive.

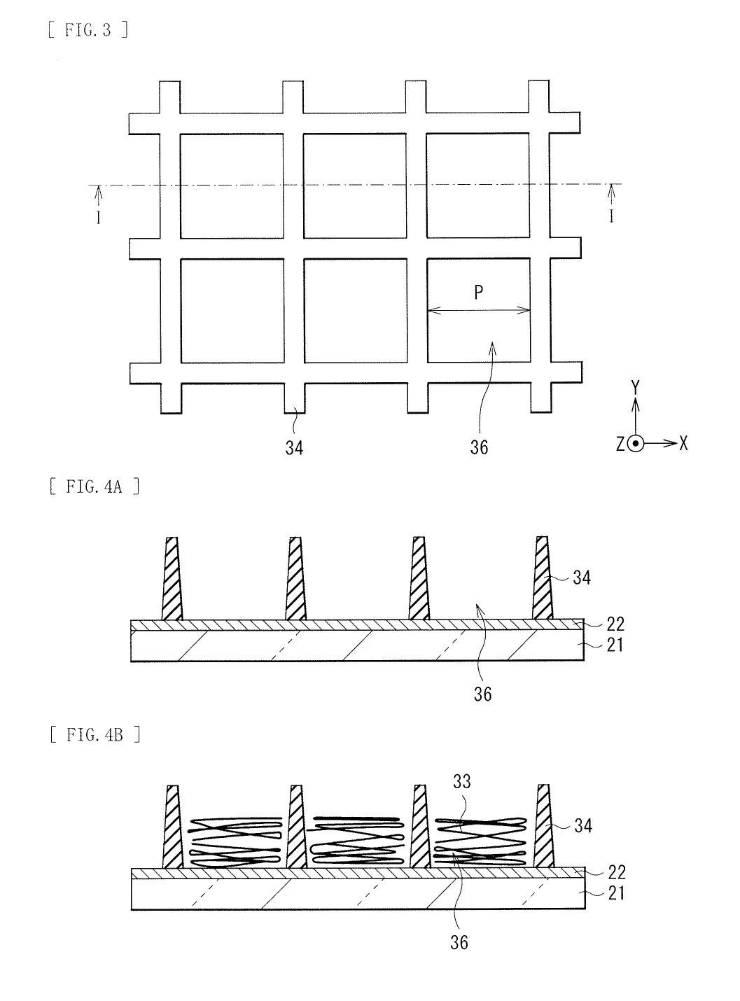

FIG. 3 illustrates a planar (XY planar) shape of the partition wall 34. Thus, the partition wall 34 is provided to form the cells 36 with a square shape. The cell 36 may have any shape, for example, a square shape or a rectangular shape. A plurality of cells 36 may be preferably arranged in a matrix form (a plurality of rows*a plurality of columns). A distance between adjacent partition walls 34 (a pitch P of the partition wall 34) in a predetermined direction (for example, the X direction) may be, for example, about 50 micrometers to about 500 micrometers both inclusive. A configuration of a section taken along a line I-I in FIG. 3 corresponds to FIG. 1.

The partition wall 34 may be preferably made of a light-transmissive material. When the partition wall 34 includes the light-transmissive material, light reflection or light absorption caused by the partition wall 34 is allowed to be suppressed. The partition wall 34 may include, for example, a photosensitive resin material as the light-transmissive material. Examples of the photosensitive resin material may include a resin capable of being photo-patterned, such as photocrosslinking reaction type, photomodification type, photopolymerization reaction type, and photodecomposition reaction type photocurable resins. The partition wall 34 may be made of one kind of photosensitive resin material, or may include a plurality of kinds of photosensitive resin materials. For example, use of a chemically stable photoresist as the photosensitive resin material is allowed to prevent the partition wall 34 from affecting a migration phenomenon of the migrating particles 32. The photoresist may be of a negative type or a positive type. Any light source, for example, a semiconductor laser, an excimer laser, electron beams, ultraviolet rays, a metal halide lamp, a high-pressure mercury vapor lamp, or the like may be used to pattern a photosensitive resin.

The sealant 40 seals the electrophoresis device 30 between the drive substrate 10 and the counter substrate 20, and may be made of, for example, an insulating material such as a polymer material. When the sealant 40 is provided, entry of water into the electrophoresis device 30 from outside is preventable. As such a sealant 40, for example, a seal material including microparticles may be used. The sealant 40 may be preferably arranged so as not to interfere with movement of the migrating particles 32. The thickness of the sealant 40 is substantially equal to the height of the partition wall 34, i.e., the gap H. The sealant 40 may protrude from an outer edge of the counter substrate 20 or the drive substrate 10.

Such a display unit 1 may be manufactured by, for example, the following processes (refer to FIGS. 4A and 4B).

First, the counter electrode 22 is provided on one surface of the supporting member 21 to form the counter substrate 20, and then the partition wall 34 is formed on the counter electrode 22 (refer to FIG. 4A). The counter electrode 22 may be formed with use of an existing method selected from various kinds of film formation methods. The partition wall 34 may be formed by, for example, the following imprinting method. First, the counter electrode 22 is coated with a solution including the material (for example, a photosensitive resin material) of the partition wall 34. Next, a mold having depressions is pressed against the counter electrode 22, the counter electrode 22 is exposed to light, and then the mold is removed. Thus, the columnar partition walls 34 are formed. In a case of the partition wall 34 with an inverse tapered shape, the mold is easily removed from the partition walls 34.

After the partition walls 34 are formed, the porous layer 33 is formed between adjacent partition walls 34, i.e., in the cell 36 (refer to FIG. 4B). More specifically, first, the porous layer 33 is formed on the counter electrode 22. The porous layer 33 is formed by adding titanium oxide as the non-migrating particles 33B to a spinning solution, sufficiently stirring the solution, and then spinning the solution into fibers. The spinning solution may be prepared by dispersing or dissolving polyacrylonitrile as the fibrous structure 33A in N,N′-dimethylformamide. For example, the electrostatic spinning method may be used for spinning. Instead of the electrostatic spinning method, the phase separation method, the phase inversion method, the melt spinning method, the wet spinning method, the dry spinning method, the gel spinning method, the sol-gel method, the spray coating method or the like may be used.

The spinning method may be preferably used to form the fibrous structure 33A. Although a method of forming a porous layer by making a hole in a polymer film with use of laser processing has been proposed (refer to Japanese Unexamined Patent Application Publication No. 2005-107146), in this method, only a large hole with a diameter of about 50 micrometers is formed, and it may be difficult to completely shield the migrating particles by the porous layer.

After the porous layer 33 is formed, the porous layer 33 is partitioned to be contained in the respective cells 36. When the porous layer 33 formed by spinning is pressed from above (a direction opposite to the supporting member 21), the porous layer 33 is rubbed and cut by the partition walls 34. The cut porous layer 33 is contained in a portion between the partition walls 34. Thus, the porous layer 33 in which the fibrous structure 33 holds the migrating particles 33B is formed in each of the cells 36.

Next, the counter substrate 20 on which the porous layer 33 is formed is coated with the insulating liquid 31 in which the migrating particles 32 are dispersed. Then, a peeling member (not illustrated) including the seal layer 16 with the sealant 40 in between is placed to face the counter substrate 20. After that, the seal layer 16 is peeled from the peeling member to be fixed to the drive substrate 10 with the adhesive layer 15. In the drive substrate 10, the TFTs 12, the protective layer 13, and the pixel electrodes 14 are formed in this order on one surface of the supporting member 11 with use of, for example, an existing method. Thus, the display unit 1 is completed by the above processes.

In an initial state of the display unit 1, all of the migrating particles 32 dispersed in the insulating liquid 31 are located on a side closer to the pixel electrodes 14 (refer to FIG. 1). At this time, when the electrophoresis device 30 is viewed from the counter substrate 20, the migrating particles 32 are shielded by the porous layer 33, and an image is not displayed.

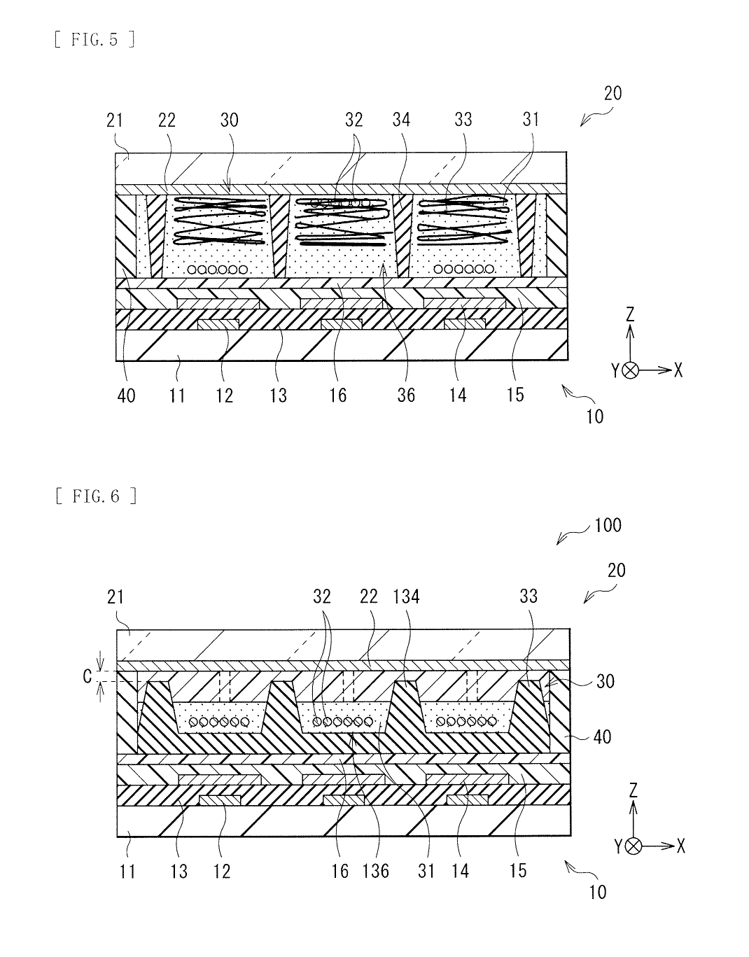

When pixels are selected by the TFTs 12, and an electric field is applied between the pixel electrodes 14 and the counter electrode 22, as illustrated in FIG. 5, in the selected pixels, the migrating particles 32 move toward the counter electrode 22 through the pores 35 of the porous layer 33. At this time, when the electrophoresis device 30 is viewed from the counter substrate 20, pixels for display in a dark state in which the migrating particles 32 are shielded by the porous layer 33 and pixels for display in a light state in which the migrating particles 32 are not shielded by the porous layer 33 coexist. Contrast is caused by the pixels for display in a dark state and the pixels for display in a light state to display an image on the counter substrate 20.

In this case, the porous layer 33 is partitioned into portions corresponding to respective cells 36; therefore, the movement of the migrating particles 32 between the cells 36 through the porous layer 33 is suppressed. In other words, a dispersion state of the migrating particles 32 is maintained in a desired state. This will be described below.

FIG. 6 illustrates a sectional configuration of a display unit (a display unit 100) according to a comparative example. In the display unit 100, as with the above-described display unit 1, a partition wall 134 is provided to prevent movement of the migrating particles 32 between the cells 36. However, a space C is provided between the partition wall 134 and the counter electrode 22, and the porous layers 33 in the cells 36 are connected to one another through the space C. In other words, the porous layer 33 is continuously formed over adjacent cells 36, and is not partitioned into portions corresponding to respective cells 36. Therefore, the migrating particles 32 may move between the cells 36 through the continuous porous layer 33, thereby resulting in a nonuniform dispersion state of the migrating particles 32 by an operation for a long time. When the dispersion state of the migrating particles 32 is nonuniform, display characteristics such as white reflectivity and black reflectivity vary in a plane. As described above, contrast is caused by a difference between white reflectivity and black reflectivity.

On the other hand, in this embodiment, the porous layer 33 is partitioned into portions corresponding to respective cells 36; therefore, the migrating particles 32 are allowed to be prevented from moving between the cells 36 through the porous layer 33. Thus, even if the display unit 1 operates for a long time, the initial dispersion state of the migrating particles 32 is maintained; therefore, variation in display characteristics in a plane is allowed to be reduced.

As described above, in the display unit 1 according to this embodiment, the porous layer 33 is partitioned into portions corresponding to the respective cells 36; therefore, the dispersion state of the cell is allowed to be maintained in a desired state, and variation in display characteristics in a plane is allowed to be reduced. Therefore, as the display unit including the porous layer, high response speed and high contrast are achievable, and display characteristics in a plane is allowed to be uniformly maintained, thereby improving display quality.

Next, modification examples of this embodiment will be described below. In the following description, like components are denoted by like numerals as of the above-described embodiment and will not be further described.

### Modification Example 1

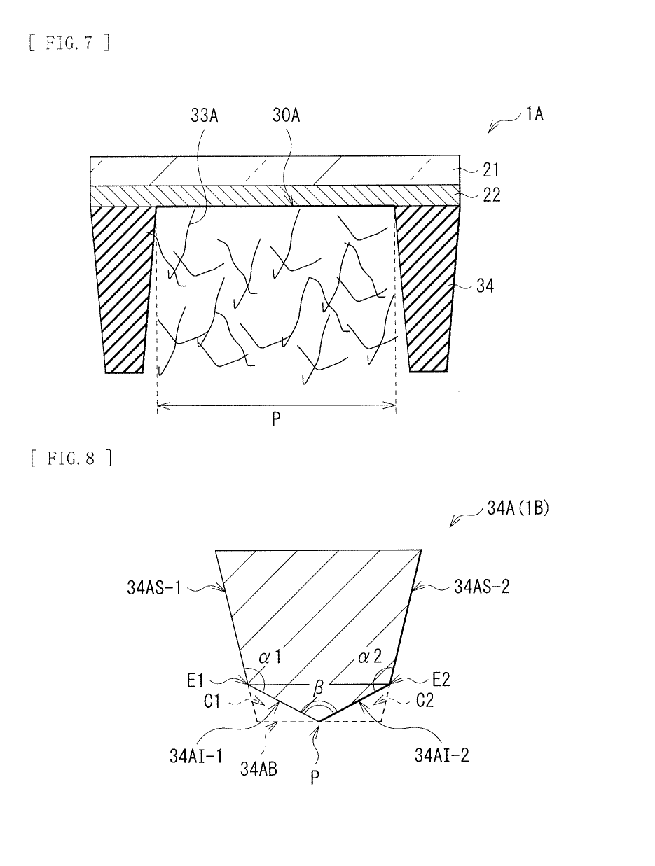

FIG. 7 illustrates a sectional configuration of a main part of a display unit (a display unit 1A) according to Modification Example 1 of the above-described embodiment. An electrophoresis device 10A of the display unit 1A includes fibrous structures 33A with a length smaller than the pitch P of the partition wall 34. The display unit 1A has a configuration similar to the display unit 1 according to the above-described embodiment, except for this point, and has functions and effects similar to those of the display unit 1.

In the electrophoresis device 30A, the length of each of the fibrous structures 33A is smaller than the pitch P of the partition wall 34. Moreover, each of the fibrous structures 33A may preferably have a longer length than the particle diameter of the non-migrating particle 33B so as to hold the non-migrating particle 33B. The fibrous structures 33A with such an adjusted length are arranged easily and uniformly in the cells 36. Therefore, the display characteristics in a plane are allowed to be uniformized, and display quality is allowed to be further improved. The length of the fibrous structure 33 may be preferably smaller than a length of a smallest side (a smallest pitch P) of the cell 36. In a case where the cell 36 has, for example, a rectangular shape, the length of the fibrous structure 33A may be smaller than a length of a short side of the cell 36. The length of such a fibrous structure 33A may be, for example, about 1 micrometers to about 200 micrometers both inclusive.

The length of the fibrous structure 33A is adjustable by cutting a fibrous material formed by a spinning method. For example, the fibrous material may be cut by frost shattering. When the fibrous structure 33A with the adjusted length is used, the porous layer 33 is easily contained in the cell 36, and is uniformly arranged. In a case where a fibrous structure with a larger length than the pitch P of the partition wall 34 is used, a process of pressing the porous layer 33 to contain the porous layer 33 in the cell 33 is necessary. Moreover, the porous layer 33 pressed by this pressing process has a dense portion and a coarse portion in the cell 36, thereby easily causing unevenness. On the other hand, when the fibrous structure 33A with a smaller length than the pitch P of the partition wall 34 is used, the pressing process may be simplified or eliminated. Therefore, the time of the process of manufacturing the display unit 1 is allowed to be reduced, and cost is allowed to be reduced. Moreover, a large force is not applied to the porous layer 33; therefore, the porous layer 33 is uniformly arranged in the cell 36. Further, when the display unit is upsized, it is difficult to uniformly press the porous layer 33 in a plane. Therefore, this modification example is easily applicable to upsizing of the display unit.

### Modification Example 2

FIG. 8 illustrates a sectional configuration of a partition wall (a partition wall 34A) of a display unit (a display unit 1B) according to Modification Example 2 of the above-described embodiment. The partition wall 34A has cutaway sections C1 and C2 between side surfaces 34AS-1 and 34AS-2 and a portion in contact with the drive substrate 10 (a part of a bottom surface 34AB). The display unit 1B has a configuration similar to the display unit 1 according to the above-described embodiment, except for this point, and has functions and effects similar to those of the display unit 1.

The cutaway sections C1 and C2 are provided between two side surfaces 33AS-1 and 34AS-2 facing each other and a surface (the bottom surface 34AB) in contact with the drive surface 10. When such two cutaway sections (the cutaway sections C1 and C2) are provided, two inclined surfaces (inclined surfaces 34AI-1 and 34AI-2) are formed in the partition wall 34A. These inclined surfaces 34AI-1 and 34A-1 form angles Alpha1 and Alpha2 with the side surfaces 34AS-1 and 34AS-2 to form corner sections E1 and E2, respectively. A tip section P with an angle Beta is formed by the inclined surface 34AI-1 and the inclined surface 34AI-2 at a position facing the drive substrate 10. When such cutaway sections C1 and C2 are provided, the corner sections E1 and E2 with the angles Alpha1 and Alpha2 and the tip section P with the angle Beta are formed. When the corner sections E1 and E2 and the tip section P come into contact with the fibrous structure 33A, the fibrous structure 33A is cut to be easily contained in the cell 36. In other words, the porous layer 33 partitioned into portions corresponding to the respective cells 36 is allowed to be easily manufactured. The angles Alpha1 and Alpha2 may be, for example, about 100 deg. to about 160 deg. both inclusive, and the angle Beta may be, for example, about 90 deg. to about 150 deg. both inclusive.

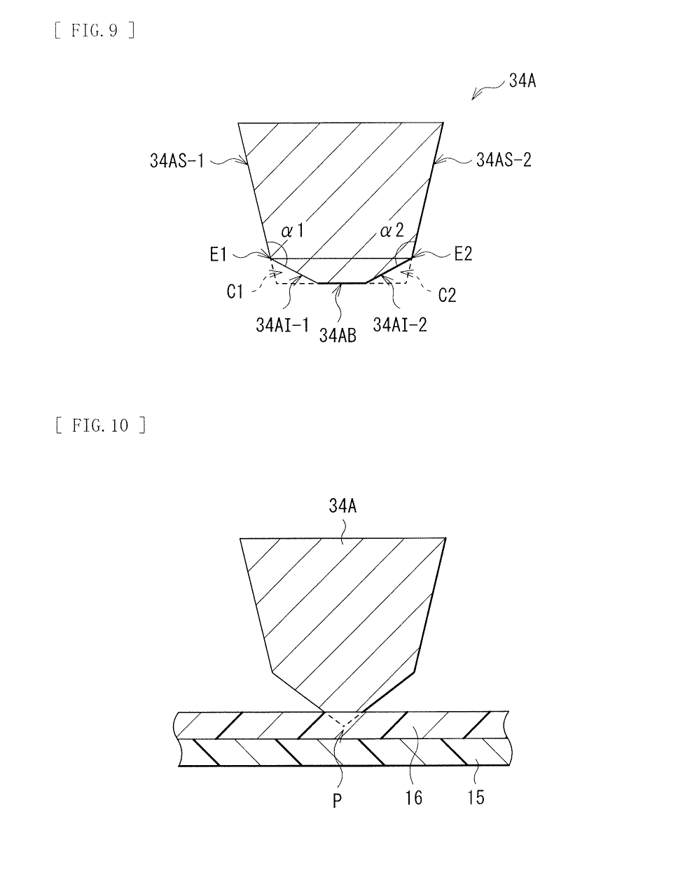

FIG. 9 illustrates a sectional shape of the partition wall 34A in which the cutaway sections C1 and C2 are formed so as to leave a part of the surface (the bottom surface 34AB) in contact with the drive substrate 10. In this partition wall 34A, a tip section (the tip section P in FIG. 8) by the inclined surface 34AI-1 and the inclined surface 34AI-2 is not provided. Thus, only the corner sections E1 and E2 may be provided without forming the tip section.

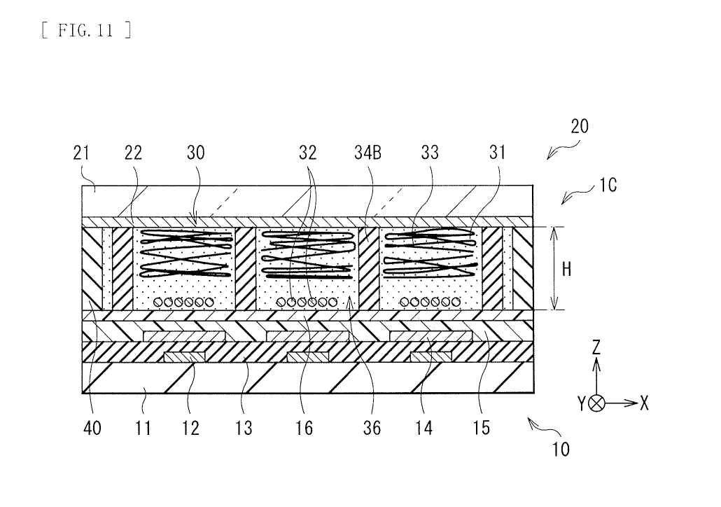

FIG. 10 illustrates an example of the partition wall 34A in contact with the seal layer 16. A part, for example, the tip section P of the partition wall 34A may be embedded in the seal layer 16.

### Modification Example 3

FIG. 11 illustrates a sectional configuration of a display unit (a display unit 1C) according to Modification Example 3 of the above-described embodiment. The display unit 1C includes a rectangular parallelepiped partition wall 34B. In the partition wall 34B, a width thereof does not change in an extending direction. In other words, the partition wall 34B has a fixed width from the drive substrate 10 to the counter substrate 20. The display unit 1C has a configuration similar to the display unit 1 according to the above-described embodiment, except for this point, and has functions and effects similar to those of the display unit 1.

Next, application examples of the above-described display units 1, 1A, 1B, and 1C will be described below. The display units 1, 1A, 1B, and 1C are allowed to be mounted in the following electronic apparatuses; however, the configurations of the electronic apparatuses that will be described below are merely examples, and may be modified as appropriate.

### Application Example 1

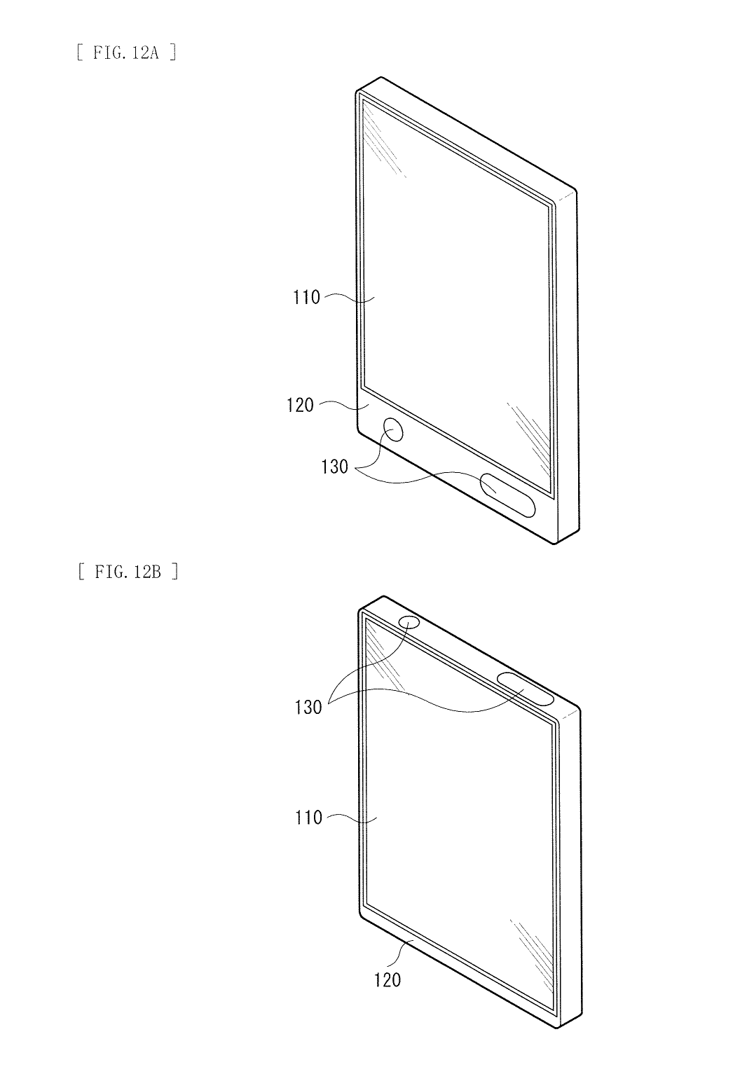

FIGS. 12A and 12B illustrate an appearance of an electronic book. The electronic book includes a display section 110, a non-display section 120, and an operation section 130. It is to be noted that the operation section 130 may be disposed on a front surface of the non-display section 120 as illustrated in FIG. 12A or may be disposed on a top surface of the non-display section 120 as illustrated in FIG. 12B. The display section 110 is configured of any one of the display units 1, 1A, 1B, and 1C. It is to be noted that the display units 1, 1A, 1B, and 1C may be mounted in a PDA (Personal Digital Assistants) with a configuration similar to the electronic book illustrated in FIGS. 12A and 12B.

### Application Example 2

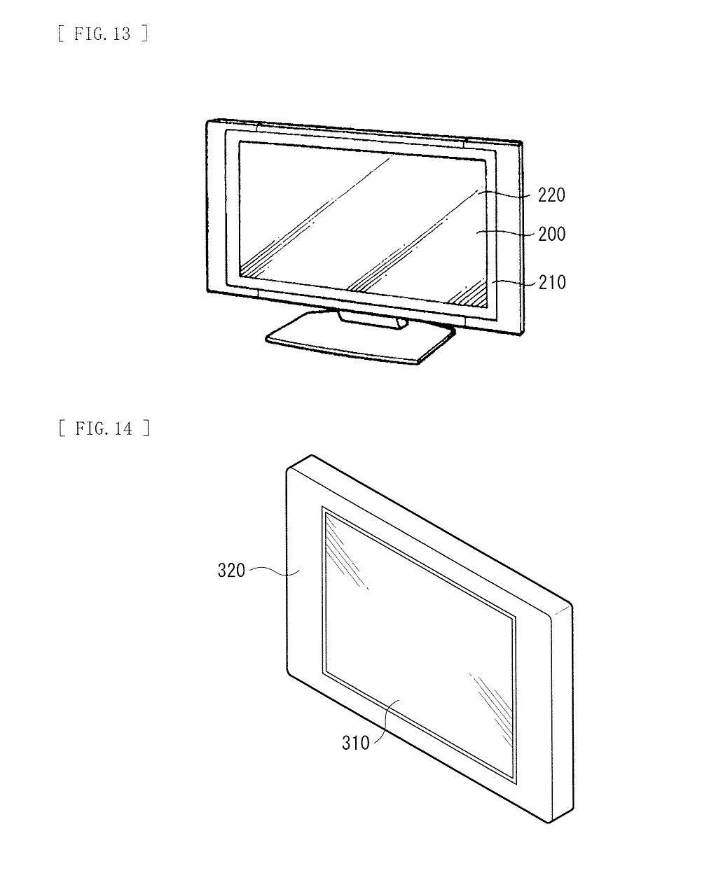

FIG. 13 illustrates an appearance of a television. The television includes, for example, an image display screen section 200 including a front panel 210 and a filter glass 220. The image display screen section 200 is configured of any one of the display units 1, 1A, 1B, and 1C.

### Application Example 3

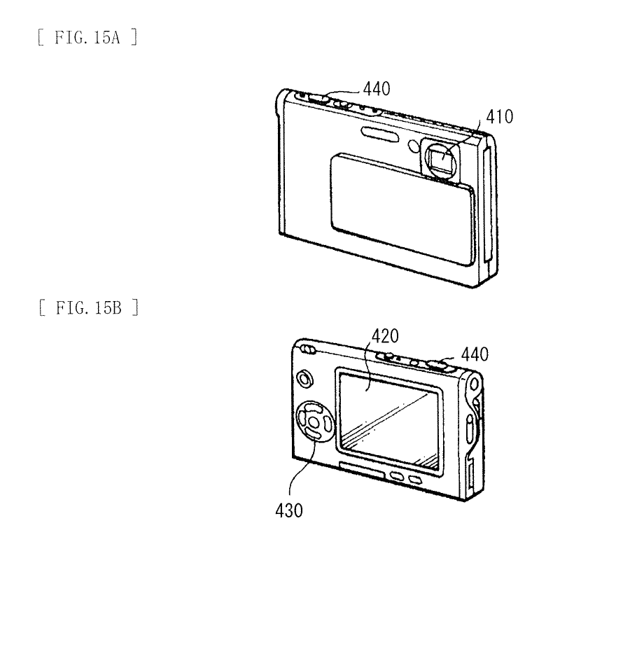

FIG. 14 illustrates an appearance of a tablet personal computer. The tablet personal computer may include, for example, a touch panel section 310 and an enclosure 320, and the touch panel section 310 is configured of any one of the above-described display units 1, 1A, 1B, and 1C.

### Application Example 4

FIG. 15A and 15B illustrate an appearance of a digital still camera, and FIG. 15A illustrates a front surface, and FIG. 15B illustrates a back surface. The digital still camera may include, for example, a light-emitting section 410 for a flash, a display section 420, a menu switch 430, and a shutter button 440. The display section 420 is configured of any one of the display units 1, 1A, 1B, and 1C.

### Application Example 5

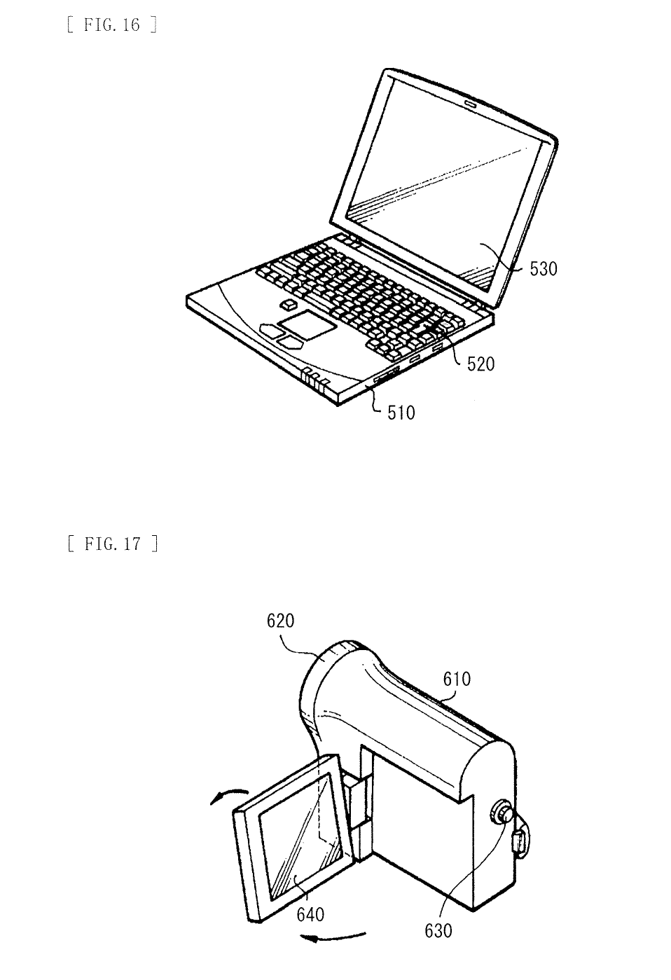

FIG. 16 illustrates an appearance of a notebook personal computer. The notebook personal computer may include, for example, a main body 510, a keyboard 520 for operation of inputting characters and the like, and a display section 530 for displaying of an image. The display section 530 is configured of any one of the display units 1, 1A, 1B, and 1C.

### Application Example 6

FIG. 17 illustrates an appearance of a video camera. The video camera may include, for example, a main section 610, a lens 620 provided on a front surface of the main section 610 and for shooting of an image of an object, a shooting start/stop switch 630, and a display section 640. The display section 640 is configured of any one of the display units 1, 1A, 1B, and 1C.

### Application Example 7

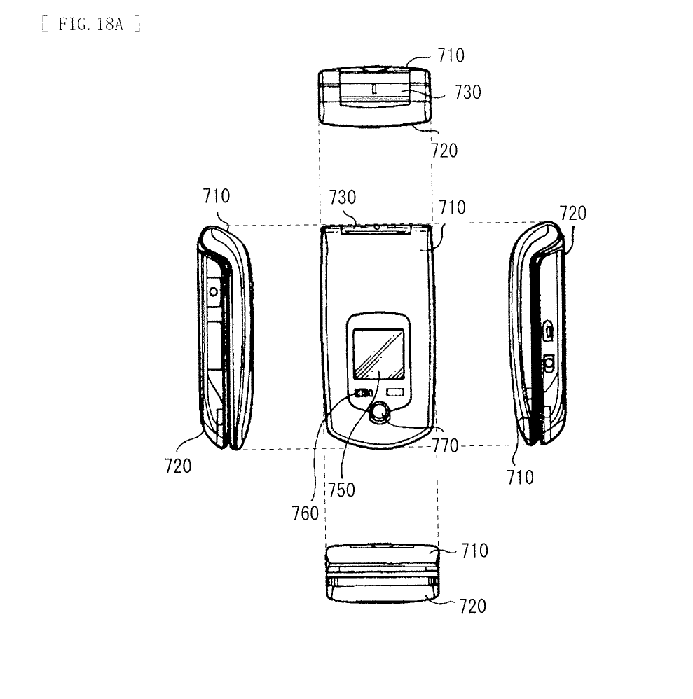

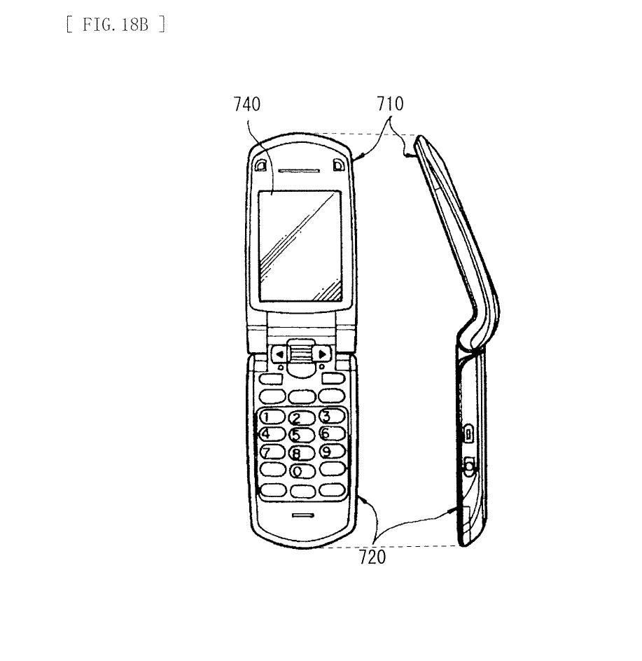

FIGS. 18A and 18B illustrate an appearance of a cellular phone. FIG. 18A illustrates a front surface, a left side surface, a right side surface, a top surface, and a bottom surface in a state in which the cellular phone is closed. FIG. 18B is a front surface and a side surface in a state in which the cellular phone is opened. The cellular phone may be formed by connecting, for example, a top-side enclosure 710 and a bottom-side enclosure 720 to each other by a connection section (hinge section) 730, and the cellular phone may include a display 740, a sub-display 750, a picture light 760, and a camera 770. The display 740 or the sub-display 750 is configured of any one of the display units 1, 1A, 1B, and 1C.

### EXAMPLES

### Examples

Next, examples of an embodiment of the present technology will be described below.

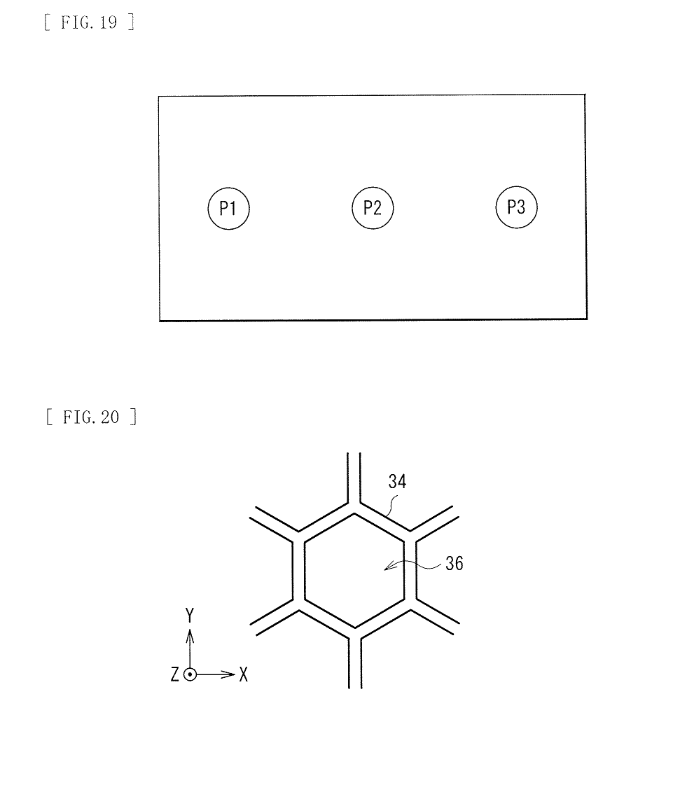

Two display units including porous layers with configurations different from each other were manufactured (Experimental Examples 1 and 2). Experimental Example 1 was a display unit (in FIG. 1, for example) in which the porous layer was partitioned into portions corresponding to respective cells, and Experimental Example 2 was a display unit (in FIG. 6, for example) in which the porous layer was continuously formed over cells. These display units of Experimental Examples 1 and 2 continuously operated for 8 hours. White reflectivity (%) and black reflectivity (%) at three points (positions P1, P2, and P3) in a display surface of each of the display units of Experimental Examples 1 and 2 at that time were measured, and results were compared to those before operation. Results are illustrated in Table 1. In Table 1, “before” represents white reflectivity and black reflectivity before operation, and “after” represents white reflectivity and black reflectivity after 8-hour operation. It is to be noted that, as illustrated in FIG. 19, the position P1 is located on a left side of the display surface, the position P2 is located at a center of the display surface, and the position P3 is located on a right side of the display surface.

### Table 1

In the display unit of Experimental Example 1, the white reflectivity and the black reflectivity after the operation at all of the positions P1, P2, and P3 were substantially maintained at the same levels as before the operation. Therefore, even after the operation, the white reflectivity and the black reflectivity at the positions P1, P2, and P3 had values close to one another, and variation depending on position was small. The white reflectivity after the operation at the positions P1, P2, and P3 was 40.1%, 40.7%, and 40.5%, respectively, and the black reflectivity after the operation at the positions P1, P2, and P3 was 2.3%, 2.3%, and 2.2%, respectively. It was confirmed that, even by visual inspection, display quality after the operation was the same as display quality before the operation.

On the other hand, in the display unit of Experimental Example 2, the white reflectivity and the black reflectivity after the operation were lower than those before the operation, and the white reflectivity and the black reflectivity after the operation greatly varied among the positions P1, P2, and P3. The white reflectivity after the operation at the positions P1, P2, and P3 was 39.8%, 41.7%, and 44.1%, respectively, and the black reflectivity after the operation at the positions P1, P2, and P3 was 2.1%, 2.0%, and 2.2%, respectively. In particular, the white reflectivity was greatly reduced. It is considered that this is caused by entry of the migrating particles into a space (the space C in FIG. 6) between the partition wall and the counter electrode by movement of the migrating particles between the cells. Contrast was reduced by such reduction in white reflectivity. Even in visual inspection, variation in gray scale among the positions in a plane was confirmed.

Therefore, it was confirmed that, in the display unit of Experimental Example 1 including the porous layer partitioned into portions corresponding to respective cells, variation in display characteristics in a plane was allowed to be reduced, and the display characteristics were allowed to be uniformly maintained.

Although the present technology is described referring to the embodiment and the modification examples, the present technology is not limited thereto, and may be variously modified. For example, the electrophoresis devices according to the embodiment and the like of the present technology may be applied to not only the display unit but also other electronic apparatuses.

Moreover, in the above-described embodiment and the like, a case where the migrating particles 32 and the porous layer 33 are contained in the square-shaped cell 36 (refer to FIG. 3) is described; however, the cell 36 may have any other shape, for example, a hexagonal shape (a honeycomb structure) as illustrated in FIG. 20.

Further, in the above-described embodiment and the like, a case where a dark state is displayed by the migrating particles 32 and a light state is displayed by the porous layer 33 is described; however, the dark state may be displayed by the porous layer 33, and the light state may be displayed by the migrating particles 32. Moreover, the dark state and the light state may be displayed by two kinds of porous layers. In this case, one of the porous layers moves by voltage application.

In addition, a case where the pitch of the partition wall 34 is equal to the pitch of the pixel electrode 14 is described; however, they may not be equal to each other.

Furthermore, in the above-described embodiment and the like, a case where the drive substrate 10 and the seal layer 16 are fixed with the adhesive layer 15 in between is described; however, the seal layer 16 may be directly fixed to the drive substrate 10.

Moreover, in the above-described embodiment and the like, a method of allowing the seal layer 16 to face the counter substrate 20 after coating the counter substrate 20 with the insulating liquid 31, is described; however, the display unit 1 may be manufactured by another method. For example, after the counter substrate 20 and the seal layer 16 are arranged to face each other, the insulating liquid 31 may be charged into a portion between the counter substrate 20 and the seal layer 16.

It is to be noted that the present technology is allowed to have following configurations.
(1) A display unit including:
a first particle contained in each of a plurality of cells; and
a porous layer provided in the cells, and partitioned into portions corresponding to the respective cells.
(2) The display unit according to (1), in which a partition wall is provided between adjacent ones of the cells.
(3) The display unit according to (2), further including a pair of substrates facing each other, in which the partition wall is in contact with both the pair of substrates.
(4) The display unit according to (3), in which the partition wall includes a cutaway section between a section thereof in contact with one of the substrates and a side surface thereof.
(5) The display unit according to (4), in which the partition wall includes two cutaway sections between the section thereof in contact with one of the substrates and side surfaces thereof, and a tip section facing one of the substrates is formed by the two cutaway sections in the partition wall.
(6) The display unit according to any one of (1) to (5), in which the porous layer includes a fibrous structure and second particles held by the fibrous structure.
(7) The display unit according to (6), in which a length of the fibrous structure is smaller than a length of a shortest side of sides of the cell.
(8) The display unit according to (7), in which the length of the fibrous structure is larger than a particle diameter of the second particle.
(9) The display unit according to any one of (1) to (8), in which the first particles are allowed to move in a thickness direction of the porous layer by voltage application.
(10) The display unit according to (6), in which light reflectivity of the second particle is different from light reflectivity of the first particle.
(11) The display unit according to (10), in which the light reflectivity of the second particle is higher than the light reflectivity of the first particle.
(12) The display unit according to any one of (1) to (11), in which the first particle is made of one or more kinds selected from a group configured of organic pigments, inorganic pigments, dyes, carbon materials, metal materials, metal oxides, glass, and polymer materials.
(13) An electronic apparatus provided with a display unit, the display unit including:
a first particle contained in each of a plurality of cells; and
a porous layer provided in the cells, and partitioned into portions corresponding to the respective cells.

It should be understood by those skilled in the art that various modifications, combinations, sub-combinations, and alterations may occur depending on design requirements and other factors insofar as they are within the scope of the appended claims or the equivalents thereof.

### REFERENCE SINGS LIST

1, 1A, 1B, 1C . . . display unit, 10 . . . drive substrate, 11 . . . supporting member, 12 . . . TFT, 13 . . . protective layer, 14 . . . pixel electrode, 15 . . . adhesive layer, 16 . . . seal layer, 20 . . . counter substrate, 21 . . . supporting member, 22 . . . counter electrode, 30 . . . electrophoresis device, 31 . . . insulating liquid, 32 . . . migrating particle, 33 . . . porous layer, 33A . . . fibrous structure, 33B . . . non-migrating particle, 34, 34A, 34B . . . partition wall, 35 . . . pore, 36 . . . cell, 40 . . . sealant

1. A display unit comprising:
a first particle contained in each of a plurality of cells; and
a porous layer provided in the cells, and partitioned into portions corresponding to the respective cells.

2. The display unit according to claim 1, wherein a partition wall is provided between adjacent ones of the cells.

3. The display unit according to claim 2, further comprising a pair of substrates facing each other,
wherein the partition wall is in contact with both the pair of substrates.

4. The display unit according to claim 3, wherein the partition wall includes a cutaway section between a section thereof in contact with one of the substrates and a side surface thereof.

5. The display unit according to claim 4, wherein the partition wall includes two cutaway sections between the section thereof in contact with one of the substrates and side surfaces thereof, and a tip section facing one of the substrates is formed by the two cutaway sections in the partition wall.

6. The display unit according to claim 1, wherein the porous layer includes a fibrous structure and a second particle held by the fibrous structure.

7. The display unit according to claim 6, wherein a length of the fibrous structure is smaller than a length of a shortest side of the cell.

8. The display unit according to claim 7, wherein the length of the fibrous structure is larger than a particle diameter of the second particle.

9. The display unit according to claim 1, wherein the first particle is allowed to move in a thickness direction of the porous layer by voltage application.

10. The display unit according to claim 6, wherein light reflectivity of the second particle is different from light reflectivity of the first particle.

11. The display unit according to claim 10, wherein the light reflectivity of the second particle is higher than the light reflectivity of the first particle.

12. The display unit according to claim 1, wherein the first particle is made of one or more kinds selected from a group consisting of organic pigments, inorganic pigments, dyes, carbon materials, metal materials, metal oxides, glass, and polymer materials.

13. An electronic apparatus provided with a display unit, the display unit comprising:
a first particle contained in each of a plurality of cells; and
a porous layer provided in the cells, and partitioned into portions corresponding to the respective cells.
